(19) United States
(12) Patent Application Publication
(10) Pub. No.: US 2020/0285230 A1
(43) Pub. Date: Sep. 10, 2020

(54) UNMANNED AERIAL VEHICLE SYSTEM AND COMMUNICATION METHOD

(71) Applicant: SZ DJI TECHNOLOGY CO., LTD., Shenzhen (CN)

(72) Inventors: Ning MA, Shenzhen (CN); Dong ZHANG, Shenzhen (CN); Xiaojun YIN, Shenzhen (CN)

(21) Appl. No.: 16/883,823

(22) Filed: May 26, 2020

Related U.S. Application Data
(63) Continuation of application No. PCT/CN2017/113919, filed on Nov. 30, 2017.

(51) Int. Cl. G05D 1/00; H04W 4/40; H04L 29/06; B64C 39/02; G05D 1/10

(52) U.S. Cl. CPC G05D 1/0038; H04W 4/40; H04L 65/4069; H04W 84/12; G05D 1/0022; G05D 1/101; B64C 39/024

(57) ABSTRACT

An unmanned aerial vehicle includes a first communication unit to communicate via a private communication protocol, a second communication unit to communicate with a standard communication protocol, and a controller unit to control the first communication unit and the second communication unit, wherein one of the first communication unit and the second communication unit is to communicate with a second unmanned aerial vehicle, and the other one of the first communication unit and the second communication unit is to communicate with a first remote controller.

### CROSS-REFERENCE TO RELATED APPLICATION

This application is a continuation of International Application No. PCT/CN2017/113919, filed Nov. 30, 2017, the entire content of which is incorporated herein by reference.

### TECHNICAL FIELD

The present disclosure relates to data communication, and in particular to communication method related to unmanned aerial vehicle.

### BACKGROUND

Unmanned aerial vehicles with imaging capacities are becoming increasingly popular. For example, unmanned aerial vehicle with one or more imaging cameras may track target objects and transmits to user captured images and video clips via wireless communications.

However, during a long distance flight, wireless signals may get blocked due to certain environmental blockage or specific circumstances, and the unmanned aerial vehicle may become unable to communicate directly with the remote controller.

### SUMMARY

In accordance with the present disclosure, there is provided an unmanned aerial vehicle including a first communication unit to communicate via a private communication protocol, a second communication unit to communicate with a standard communication protocol, and a controller unit to control the first communication unit and the second communication unit, wherein one of the first communication unit and the second communication unit is to communicate with a second unmanned aerial vehicle, and the other one of the first communication unit and the second communication unit is to communicate with a first remote controller.

Also in accordance with the present disclosure, there is provided an unmanned aerial vehicle system including a first unmanned aerial vehicle and a first remote controller, wherein the first unmanned aerial vehicle includes a first communication unit to communicate via a private communication protocol; a second communication unit to communicate with a standard communication protocol; and a controller unit to control the first communication unit and the second communication unit, wherein one of the first communication unit and the second communication unit to communicate with a second unmanned aerial vehicle, and the other one of the first communication unit and the second communication unit to communicate with the first remote controller, and wherein the first remote controller controls the first unmanned aerial vehicle or controls a second unmanned aerial vehicle via communication with the first unmanned aerial vehicle.

### BRIEF DESCRIPTION OF THE DRAWINGS

Objectives, features, and advantages of the embodiments are more readily understandable in reference to the accompanying drawings described below. In the accompanying drawings, the embodiments are described without limiting the scope of the present disclosure.

FIG. 1 is a schematic box diagram of an unmanned aerial vehicle according to one embodiment of the present disclosure.

FIG. 2 is a schematic flow chart diagram of a method executed by an unmanned aerial vehicle according to another embodiment of the present disclosure.

FIG. 3 is a schematic box diagram of an unmanned aerial vehicle system according to yet another embodiment of the present disclosure.

FIG. 4 is a schematic flow chart diagram of a method executed by an unmanned aerial vehicle according to yet another embodiment of the present disclosure.

FIG. 5 is a schematic diagram of a computer readable storage medium according to yet another embodiment of the present disclosure.

FIG. 6 is a schematic diagram of relay communication via an unmanned aerial vehicle according to yet another embodiment of the present disclosure.

FIG. 7 is a schematic diagram of relay communication via an unmanned aerial vehicle according to yet another embodiment of the present disclosure.

FIG. 8 is a schematic diagram of relay communication via an unmanned aerial vehicle according to yet another embodiment of the present disclosure.

FIG. 9 is a schematic diagram of relay communication via an unmanned aerial vehicle according to yet another embodiment of the present disclosure.

It should be noted that the drawings are not necessarily drawn to scale, rather emphasis is on illustrating the principles of the technology disclosed herein. In addition, for the sake of clarity, like reference numerals refer to like elements throughout the drawings

### DETAILED DESCRIPTION OF THE EMBODIMENTS

Descriptions are provided below to embodiments of the present disclosure in view of the drawings. The present disclosure, however, is not to be limited to the embodiment(s) detailed below. Moreover, description of certain well-known techniques or knowledge is minimized or omitted in favor of brevity and to avoid unnecessary confusion to understanding of the present disclosure.

Embodiment(s) of the present disclosure provide an unmanned aerial vehicle with two communication units as a relay unmanned aerial vehicle, where one communication unit communicates with private communication protocol, and the other communication unit communicates via standard communication protocol. In some embodiments, the relay unmanned aerial vehicle includes two communication units, one communication unit communicating via private communication protocol, the other communication unit communicating via WiFi communication protocol. Operating with the private communication unit and the WiFi communication unit, the relay unmanned aerial vehicle communicates with a second unmanned aerial vehicle and a corresponding remote controller.

Principles applicable to the present disclosure may also be employed in other unmanned aerial vehicle or unmanned aerial vehicle system with two or more communication units.

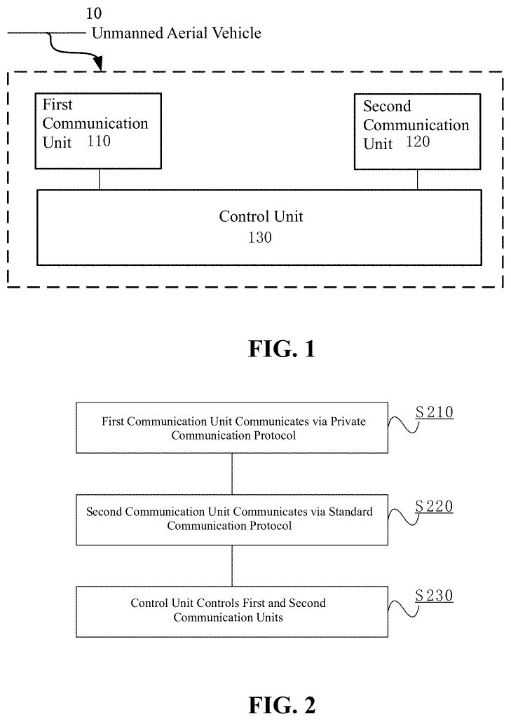

FIG. 1 is a schematic box diagram of an unmanned aerial vehicle according to one embodiment of the present disclosure. As illustratively depicted in FIG. 1, the unmanned aerial vehicle 10 includes a first communication unit 110, a second communication unit 120, and a control unit 130.

The first communication unit 110 may communicate via a private communication protocol. For example, the first communication unit 110 may communicate with the remote controller or another unmanned aerial vehicle via private communication protocol, to transmit information on images, videos and/or instructions. The private communication protocol may include OcuSync image communication protocol.

The second communication unit 120 communicates via a standard communication protocol. For example, the second communication unit 120 may communicate with the remote controller or another unmanned aerial vehicle via a WiFi communication protocol, to transmit information on images, videos, and other instructions.

The control unit 130 controls the first communication unit 110 and the second communication unit 120, such that one of the first communication unit 110 and the second communication unit 120 communicates with another or a second unmanned aerial vehicle, and the other of the first communication unit 110 and the second communication unit 120 communicates with the first remote controller. The first remote controller controls operation of the unmanned aerial vehicle 10, or controls the second unmanned aerial vehicle via relay communication through the relay unmanned aerial vehicle.

For example, the control unit 130 communicates with the first communication unit 110 and the first remote controller, and controls communication between the second communication unit 120 and the second unmanned aerial vehicle. The unmanned aerial vehicle 10 communicates with the first remote controller via private communication protocol and communicates with the second unmanned aerial vehicle via standard communication protocol.

The control unit 130 may control communications between the first communication unit 110 and a second remote controller, such that the first remote controller controls the second unmanned aerial vehicle, and the second remote controller controls the first or relay unmanned aerial vehicle. The first unmanned aerial vehicle communicates with the first remote controller and the second remote controller via private communication protocol.

In some embodiments, the control unit 130 communicates with the second unmanned aerial vehicle via the first communication unit 110, and controls communication between the second communication unit 120 and the first remote controller. Accordingly, the unmanned aerial vehicle 10 communicates with the second unmanned aerial vehicle via private communication protocol, and communicates with the first remote controller via standard communication protocol.

The control unit 130 may control communications between the second communication unit 120 and the second remote controller, such that the first remote controller controls the second unmanned aerial vehicle, and the second remote controller controls the unmanned aerial vehicle 10. Accordingly, the unmanned aerial vehicle 10 communicates with the first remote controller and the second remote controller via stand communication protocol.

In some embodiments, and to avoid interference between the two communication protocols, the first communication unit 110 and the second communication unit 120 may work at different frequencies. For example, the first communication unit 110 communicates via OcuSync private image communication protocol, and the second communication unit 120 communicates via WiFi communication protocol. Accordingly, communication via the OcuSync mediated operation may be conducted at 5.8 GHz frequency, and communication via the WiFi mediated operation may be conducted at 2.4 GHz. Alternatively, communication via the OcuSync mediated operation may be conducted at 2.4 GHz frequency, and communication via the WiFi mediated operation may be conducted at 5.8 GHz.

In some embodiments, the control unit 130 may receive image information from the second unmanned aerial vehicle via the first or second communication unit 110, 112 that is in communication with the second unmanned aerial vehicle, and transmits the image information to the first remote controller via the second or first communication unit 112, 110 that is communication with the first remote controller. Accordingly, the unmanned aerial vehicle 10 functions as a relay unmanned aerial vehicle for the second unmanned aerial vehicle, such that image information captured by the second unmanned aerial vehicle may arrive at the first remote controller through the unmanned aerial vehicle 10.

In some embodiments, the control unit 130 transmits to the first remote controller image information captured by the unmanned aerial vehicle 10 via the first or second communication unit 110, 120 in communication with the first remote controller. The image information from the unmanned aerial vehicle 10 is transmitted to the first remote controller, and image information from the second unmanned aerial vehicle is transmitted to the first remote controller via the unmanned aerial vehicle 10 as a relay unmanned aerial vehicle.

According to embodiment(s) of the present disclosure, consumer grade unmanned aerial vehicle may be employed as a relay unmanned aerial vehicle, to increase communication scope and capacity of the unmanned aerial vehicle. The embodiment(s) of the present invention may thus alleviate issues associated with limited communication due to blockage or interference.

FIG. 2 is a schematic flow chart diagram of a method executed by the unmanned aerial vehicle according to another embodiment of the present disclosure. For example, the method illustratively depicted in FIG. 1 may be executed through the first communication unit, the second communication unit, and the control unit. Below are more details of various parts of the method illustratively depicted in FIG. 2. The component steps shown in boxes do not need to be executed in the order shown. Rather, these steps may be executed in any suitable order, independently or in combination.

At box S210, the first communication unit of the unmanned aerial vehicle communicates via private communication protocol. For example, the first communication unit may communicate with the remote controller or another unmanned aerial vehicle via OcuSync private communication protocol.

At box S220, the second communication unit of the unmanned aerial vehicle communicates via standard communication protocol. For example, the second communication unit may communicate with the remote controller or another unmanned aerial vehicle via WiFi communication protocol.

At box S230, the control unit of the unmanned aerial vehicle controls the first communication unit and the second communication unit, such that the first or second communication unit communicates with another or second unmanned aerial vehicle, and the second or first communication unit communicates with the first remote controller.

For example, the control unit controls communication between the first communication unit and the first remote controller, and controls communication between the second communication unit and another or second unmanned aerial vehicle. The control unit controls communication between the first communication unit and the second remote controller, such that the first remote controller controls the second unmanned aerial vehicle and the second remote controller controls the first unmanned aerial vehicle.

In some embodiments, the control unit controls communication between the first communication unit and the second unmanned aerial vehicle, and controls communication between the second communication unit and the first remote controller. The control unit controls communication between the second communication unit and the second remote controller, such that the first remote controller controls the second unmanned aerial vehicle and the second remote controller controls the first unmanned aerial vehicle.

In some embodiments, the first communication unit and the second communication unit work at different frequencies. For example, the first communication unit may communicate at a frequency of 5.8 GHz, and the second communication unit may communicate at a frequency of 2.4 GHz, and vice versa.

In some embodiments, the control unit may receive image information from the second unmanned aerial vehicle via the first or second communication unit in communication with the second unmanned aerial vehicle, and transmit the image information to the first remote controller via the second or first communication unit in communication with the first remote controller. Accordingly, and as a reply unmanned aerial vehicle, the first unmanned aerial vehicle obtains the image information from the second unmanned aerial vehicle and forwards the image information to the first remote controller.

In some embodiments, the control unit may forward the image information captured by the relay unmanned aerial vehicle to the first remote controller via the first or second communication unit in communication with the first remote controller. Accordingly, image information from the relay unmanned aerial vehicle may be directly transmitted to the first remote controller, and image information from the second unmanned aerial vehicle may be forwarded to the first remote controller via the relay unmanned aerial vehicle.

Above is a description to an unmanned aerial vehicle and a method executed by the unmanned aerial vehicle. Below is a description of an unmanned aerial vehicle, an unmanned aerial vehicle system including a corresponding remote controller, and a method executed by the unmanned aerial vehicle system.

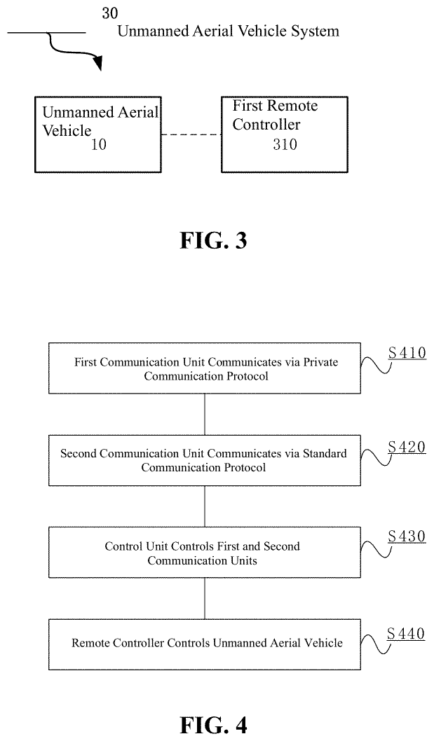

FIG. 3 is a schematic box diagram of an unmanned aerial vehicle system according to an embodiment of the present disclosure. As illustratively depicted in FIG. 3, an unmanned aerial vehicle system 30 includes an unmanned aerial vehicle 10 and a first remote controller 310. The unmanned aerial vehicle 10 may be the unmanned aerial vehicle 10 illustratively depicted in FIG. 1. Various component parts of the unmanned aerial vehicle system 30 as illustratively depicted in FIG. 3 are described below in more detail.

As illustratively depicted in FIG. 1, the unmanned aerial vehicle 10 may include the first communication unit 110, the second communication unit 120, and the control unit 130. As described herein elsewhere, the first communication unit 110 may communicate via a private communication protocol (such as OcuSync private image-transfer protocol), and the second communicate unit 120 may communicate via a standard communication protocol (such as WiFi communication protocol).

The control unit 130 of the unmanned aerial vehicle 10 controls the first communication unit 110 and the second communication unit 120, such that one of the first communication unit 110 and the second communication unit 120 communicates with another or the second unmanned aerial vehicle, and the other one of the first communication unit 110 and the second communication unit 120 communicates with the first remote controller 310. The first remote controller 310 controls the unmanned aerial vehicle 10 or controls the second unmanned aerial vehicle via a relay unmanned aerial vehicle 10.

The control unit 130 controls communication between the first communication unit 110 and the first remote controller, and controls communication between the second communication unit 120 and the second unmanned aerial vehicle. Further, the control unit 130 controls communication between the first communication unit 110 and a second remote controller, such that the first remote controller may control the second unmanned aerial vehicle, and the second remote controller controls the unmanned aerial vehicle 10.

In some embodiments, the control unit 130 controls communication between the first communication unit 110 and the second unmanned aerial vehicle, and controls communication between the second communication unit 120 and the first remote controller. Further, the control unit 130 controls communication between the second communication unit 120 and the second remote controller, such that the first remote controller controls the second unmanned aerial vehicle, and the second remote controller controls the unmanned aerial vehicle 10.

In some embodiments, and to reduce interference between the dual communication units, the first communication unit 110 and the second communication unit 120 of the unmanned aerial vehicle 10 may operate at different operation frequencies. For example, the first communication unit 110 may operate at frequency of 5.8 GHz, and the second communication unit 120 may operate at frequency of 2.4 GHz, and vice versa.

The unmanned aerial vehicle 10 may be a relay unmanned aerial vehicle for another or second unmanned aerial vehicle, such that image information of the second unmanned aerial vehicle may arrive at the first remote controller 310 via the unmanned aerial vehicle 10. In some embodiments, the image information captured by the unmanned aerial vehicle 10 may be directly transmitted to the first remote controller 310, and image information from the second unmanned aerial vehicle may arrive at the first remote controller 310 via the unmanned aerial vehicle 10 as the relay unmanned aerial vehicle.

FIG. 4 is a schematic flow chart diagram of a communication method executed by an unmanned aerial vehicle. For example, the communication method may be executed by the unmanned aerial vehicle system including the unmanned aerial vehicle and the first remote controller as illustratively depicted in FIG. 3. Below is a description of various component steps of the communication method as illustratively depicted in FIG. 4. The component steps shown in boxes do not need to be executed in the order shown. Rather, these steps may be executed in any suitable order, independently or in combination.

At box S410, the first communication unit of the unmanned aerial vehicle communicates via a private communication protocol. As mentioned herein above, the first communication system may communicate with the remote controller or another unmanned aerial vehicle via OcuSync private communication protocol.

At box S420, the second communication unit of the unmanned aerial vehicle communicates via a standard communication protocol. As mentioned above, the second communication unit may communicate with the remote controller or another unmanned aerial vehicle via WiFi standard communication protocol.

At box S430, the control unit of the unmanned aerial vehicle controls the first communication unit and the second communication unit, such that one of the first communication unit and the second communication unit communicates with the second unmanned aerial vehicle, and the other one of the first communication unit and the second communication unit communicates with the first remote controller.

At box S440, the first remote controller, which may be the relay remote controller, controls the first unmanned aerial vehicle which may be the relay unmanned aerial vehicle, or controls the second unmanned aerial vehicle which may be the remote unmanned aerial vehicle.

For example, the controller unit controls communication between the first communication unit and the first remote controller, and controls communication between the second communication unit and the second unmanned aerial vehicle. Further, the control unit may control communications between the first communication unit and the second remote controller, such that the first remote controller may control the second unmanned aerial vehicle, and the second remote controller may control the first unmanned aerial vehicle.

In some embodiments, the control unit may control communications between the first communication unit and the second unmanned aerial vehicle and may control communications between the second communication unit and the first remote controller. Further, the control unit may control communications between the second communication unit and the second remote controller, such that the first remote controller controls the second unmanned aerial vehicle, and the second remote controller controls the first unmanned aerial vehicle.

In some embodiments, the first communication unit and the second communication unit may operate at different frequencies. For example, the first communication unit may communicate via operating at 5.8 GHz, and the second communication unit may communicate via operating at 2.4 GHz, and vice versa.

In some embodiments, the control unit may receive images from the second unmanned aerial vehicle via first or second communication unit in communication with the second unmanned aerial vehicle, and transmits the images to the first remote controller via the second or first communication unit in communication with the first remote controller. The first unmanned aerial vehicle may function as a relay unmanned aerial vehicle of the second manned aerial vehicle, such that images from the second unmanned aerial vehicle may arrive at the first remote controller via the relay unmanned aerial vehicle.

In some embodiments, the control unit may transmit image information captured by the relay unmanned aerial vehicle to the first remote controller via control of the first or second communication unit in communication with the first remote controller. Image information from the relay unmanned aerial vehicle may be directly transmitted to the first remote controller, and image information from the second unmanned aerial vehicle may be transmitted to the first remote controller via the relay unmanned aerial vehicle.

Below is a description of the embodiment(s) of the present disclosure in view of FIG. 6 through FIG. 9.

FIG. 6 is a schematic diagram of a relay unmanned aerial vehicle conducting relay communications. As illustratively depicted in FIG. 6, a relay unmanned aerial vehicle, which may be the unmanned aerial vehicle 10 illustratively depicted in FIG. 1, communicates via WiFi communication protocol with a remote unmanned aerial vehicle as an example of the second unmanned aerial vehicle. The replay unmanned aerial vehicle communicates with the remote controller via OcuSync communication protocol.

To avoid possible interference between the WiFi communication protocol operation and the OcuSync communication protocol operation, communication via the WiFi mediated operation may be conducted at 2.4 GHz frequency, and communication via the OcuSync mediated operation may be conducted at 5.8 GHz. Alternatively, communication via the WiFi mediated operation may be conducted at 5.8 GHz frequency, and communication via the OcuSync mediated operation may be conducted at 2.4 GHz.

As illustratively depicted in FIG. 6, the remote controller controls flight of the relay unmanned aerial vehicle or the remote unmanned aerial vehicle, and the control may be facilitated by selection of operation parameters of the remote controller.

As illustratively depicted in FIG. 6, images captured by the relay unmanned aerial vehicle may be transmitted or sent to the remote controller via OcuSync communication protocol. On the other hand, images captured by the remote unmanned aerial vehicle may first be transmitted to the relay unmanned aerial vehicle via WiFi communication protocol, and then to the remote controller through the relay unmanned aerial vehicle via OcuSync communication protocol.

Accordingly, the remote controller may be collaborating with the relay unmanned aerial vehicle, to receive images captured by the replay unmanned aerial vehicle, to receive images captured and from the remote unmanned aerial vehicle via the relay unmanned aerial vehicle, or to receive both images captured by the relay and remote aerial vehicles.

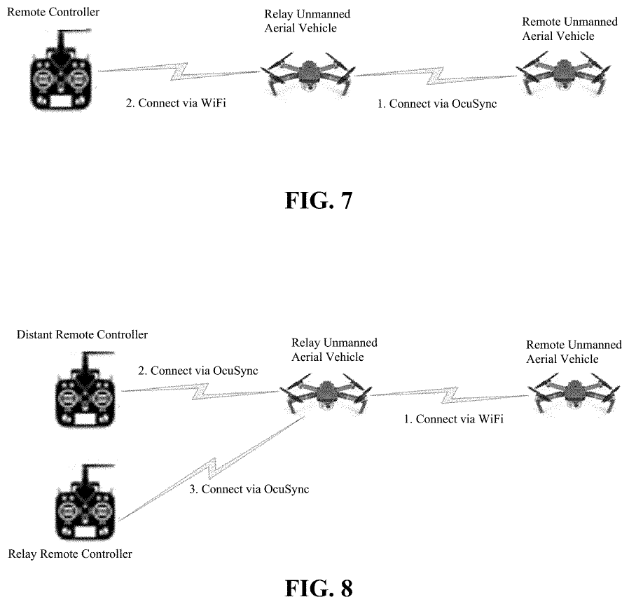

FIG. 7 is a schematic diagram of relay communication via a relay unmanned aerial vehicle. As illustratively depicted in FIG. 7, a relay unmanned aerial vehicle, which may be the unmanned aerial vehicle 10 illustratively depicted in FIG. 1, communicates via OcuSync communication protocol with a remote unmanned aerial vehicle as an example of the second unmanned aerial vehicle. The replay unmanned aerial vehicle communicates with the remote controller via WiFi communication protocol.

To avoid possible interference between the WiFi communication protocol operation and the OcuSync communication protocol operation, communication via the WiFi mediated operation may be conducted at 2.4 GHz frequency, and communication via the OcuSync mediated operation may be conducted at 5.8 GHz. Alternatively, communication via the WiFi mediated operation may be conducted at 5.8 GHz frequency, and communication via the OcuSync mediated operation may be conducted at 2.4 GHz.

As illustratively depicted in FIG. 7, the remote controller controls flight of the relay unmanned aerial vehicle or the remote unmanned aerial vehicle, and the control may be facilitated by selection of operation parameters of the remote controller.

As illustratively depicted in FIG. 7, images captured by the relay unmanned aerial vehicle may be directly transmitted or sent to the remote controller. On the other hand, images captured by the remote unmanned aerial vehicle may first be transmitted to the relay unmanned aerial vehicle via OcuSync communication protocol, and then to the remote controller through the relay unmanned aerial vehicle via WiFi communication protocol.

Accordingly, the remote controller may be collaborating with the relay unmanned aerial vehicle, to receive images captured by the replay unmanned aerial vehicle, to receive images captured and from the remote unmanned aerial vehicle via the relay unmanned aerial vehicle, or to receive both images captures by the relay and remote aerial vehicles.

FIG. 8 is a schematic diagram of a relay unmanned aerial vehicle conducting relay communications. As illustratively depicted in FIG. 8, a relay unmanned aerial vehicle, which may be the unmanned aerial vehicle 10 illustratively depicted in FIG. 1, communicates via WiFi communication protocol with a remote unmanned aerial vehicle as an example of the second unmanned aerial vehicle. Different than FIG. 6, FIG. 8 demonstrates two remote controllers, a relay remote controller and a distant remote controller, both of which may communicate with the relay unmanned aerial vehicle via OcuSync communication protocol.

As illustratively depicted in FIG. 8, the relay remote controller controls flight of the relay unmanned aerial vehicle, and the distant remote controller controls flight of the remote unmanned aerial vehicle. Accordingly, the two remote controllers are employed to respectively control two unmanned aerial vehicles, in a so-called dual control mode.

To avoid possible interference between the WiFi communication protocol operation and the OcuSync communication protocol operation, communication via the WiFi mediated operation may be conducted at 2.4 GHz frequency, and communication via the OcuSync mediated operation may be conducted at 5.8 GHz. Alternatively, communication via the WiFi mediated operation may be conducted at 5.8 GHz frequency, and communication via the OcuSync mediated operation may be conducted at 2.4 GHz.

As illustratively depicted in FIG. 8, images captured by the relay unmanned aerial vehicle may be transmitted or sent to the relay remote controller via OcuSync communication protocol. Images captured by the remote unmanned aerial vehicle may first be transmitted to the relay unmanned aerial via WiFi communication protocol, and then to the distant remote controller through the relay unmanned aerial vehicle via OcuSync communication protocol. Accordingly, and as illustratively depicted in FIG. 8, the relay remote controller and the distant remote control may receive image information from the relay unmanned aerial vehicle and the remote unmanned aerial vehicle, respectively.

Accordingly, the relay remote controller may be collaborating with the relay unmanned aerial vehicle, to receive images captured by the replay unmanned aerial vehicle, to receive images captured and from the remote unmanned aerial vehicle via the relay unmanned aerial vehicle, or to receive both images captured by the relay and remote aerial vehicles.

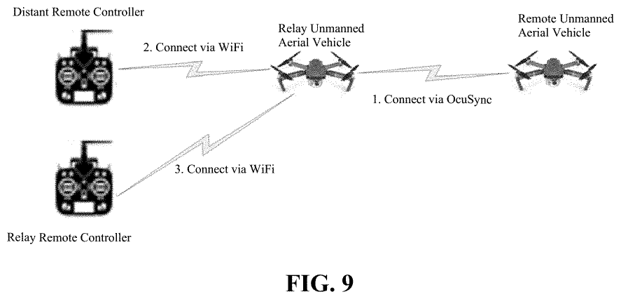

FIG. 9 is a schematic diagram of relay communication via a relay unmanned aerial vehicle. As illustratively depicted in FIG. 7, a relay unmanned aerial vehicle, which may be the unmanned aerial vehicle 10 illustratively depicted in FIG. 1, communicates via OcuSync communication protocol with a remote unmanned aerial vehicle as an example of the second unmanned aerial vehicle. Differing than FIG. 7, FIG. 9 demonstrates two remote controllers, namely the relay remote controller and the distant remote controller, both of which communicating with the relay unmanned aerial vehicle via WiFi communication protocol.

Accordingly, and as illustratively depicted in FIG. 9, the relay remote controller controls flight of the relay unmanned aerial vehicle, and the distant remote controller controls flight of the remote unmanned aerial vehicle. Accordingly, the two remote controllers are employed to respectively control two unmanned aerial vehicles, in a so-called dual control mode.

To avoid possible interference between the WiFi communication protocol operation and the OcuSync communication protocol operation, communication via the WiFi mediated operation may be conducted at 2.4 GHz frequency, and communication via the OcuSync mediated operation may be conducted at 5.8 GHz. Alternatively, communication via the WiFi mediated operation may be conducted at 5.8 GHz frequency, and communication via the OcuSync mediated operation may be conducted at 2.4 GHz.

As illustratively depicted in FIG. 9, images captured by the relay unmanned aerial vehicle may be directly transmitted or sent to the relay remote controller via WiFi communication protocol. Images captured by the remote unmanned aerial vehicle may first be transmitted to the relay unmanned aerial vehicle via OcuSync communication protocol, and then to the distant remote controller through the relay unmanned aerial vehicle via WiFi communication protocol. Accordingly, and as illustratively depicted in FIG. 9, the relay remote controller and the distant remote controller may respectively receive images from the relay unmanned aerial vehicle and the remote unmanned aerial vehicle.

Accordingly, the relay remote controller may be collaborating with the relay unmanned aerial vehicle, to receive images captured by the replay unmanned aerial vehicle, to receive images captured and from the remote unmanned aerial vehicle via the relay unmanned aerial vehicle, or to receive both images captured by the relay and remote aerial vehicles.

By providing a relay unmanned aerial vehicle which may be a consumer grade unmanned aerial vehicle with dual communication units, the present disclosure helps increase communication capacity of the unmanned aerial vehicle.

Embodiment(s) of the present disclosure may be implemented via computer program products. For example, the computer program products may include computer readable storage medium. Computer programs are stored in the computer readable storage medium, when executed by a computing device, may be configured to execute corresponding step(s) related to the technical solutions described herein.

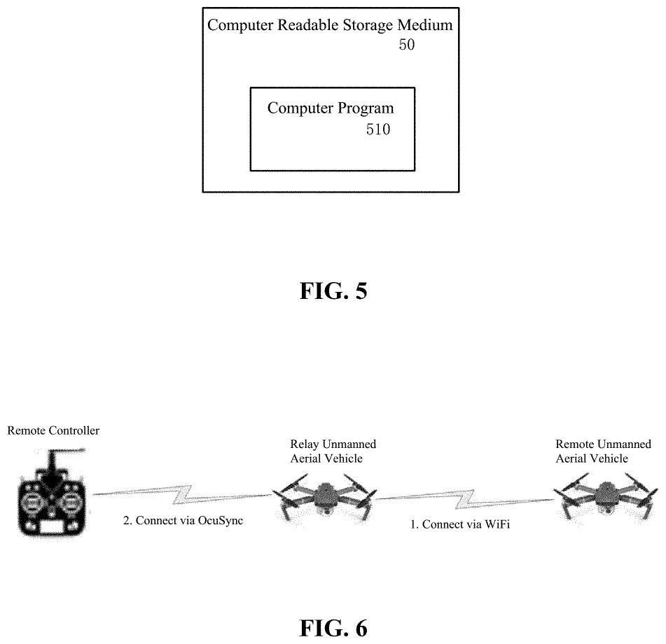

For example, FIG. 5 is a schematic box diagram of a computer readable storage medium 50 according to one embodiment of the present disclosure. As illustratively depicted in FIG. 5, the computer readable storage medium 50 includes computer program 510. When executed by at least one processor, the computer program 510 causes the at least one processor to perform various steps of the method illustratively depicted in FIG. 2 and FIG. 4. The computer readable storage medium 50 may include but not limited to semiconductor storage medium, optical storage medium, magnetic storage medium, or any other suitable computer readable storage medium.

Above is a description of method and apparatus according to embodiment(s) of the present disclosure. It is understood that the method disclosed herein is illustrative only. Methods of the present disclosure are not limited to the boxes and orders employed herein above.

It is understood that embodiment(s) of the present disclosure may be executed via software, hardware, and any combinations thereof. The present disclosure in some embodiments provides configuration or programming of software, code and/or other data structures on computer readable medium of optical medium (such as CD-ROM), floppy disc, or hard disc, or of firmware or microcode on one or more ROM, RAM, or PROM chips, or downloadable software images and shared database of one or more modules. Software or firmware or such a configuration may be installed on a computing device, such that one or more processors of the computing device may execute the technical solutions referenced in the embodiment(s) of the present disclosure.

In addition, functional modules or various features of a device or an apparatus employed in the embodiment(s) of the present disclosure may be implemented or performed via a circuit, where the circuit may be one or more integrated circuits. The circuits employed in the embodiment(s) of the present disclosure may include general-purpose processor, digital signal processors (DSP), application-specific integrated circuits (ASICs), general-purpose integrated circuits, field-programmable gate arrays (FPGA), other programmable logic devices, discrete gate or transistor logic, discrete hardware components, or any combinations of the above. A general-purpose processor may be a microprocessor, or the processor may be an existing processor, a controller, microcontroller, or a state machine. The above-mentioned general-purpose processor or each of the circuits may be configured by a digital circuit, or may be configured by a logic circuit. In addition, as advanced technologies in the semiconductor area become more available in replacing integrated circuits, such advanced technologies in the semiconductor area may also be implemented or employed in the embodiment(s) of the present disclosure.

The program running on devices according to embodiment(s) of the present disclosure may be programs employed in computers via controls on central processing unit (CPU). The program or the information processed by the program may be temporarily stored in volatile memory (such as random-access memory RAM), hard disk drive (HDD), non-volatile memory (such as flash memory), or other memory systems. The program for realizing various functions of the embodiment(s) of the present invention may be recorded on a computer-readable recording medium. Corresponding functions can be realized by causing a computer system to read programs recorded on the recording medium and to execute the programs. The “computer system” herein may be a computer system embedded in a device and may include an operating system or hardware (such as a peripheral device).

As shown above, detailed description has been provided to various embodiments of the present disclosure. However, the above-mentioned embodiments are not necessarily limited to any specific structures, and the present disclosure also includes any design changes that do not depart from the gist of the present disclosure. In addition, the present invention can be modified within the scope of the claims, and the embodiments obtained via integrating the technical features disclosed in the different embodiments are also included in the technical scope of the present disclosure. Moreover, components having the same effects described in the above embodiments may be interchangeable between one and another.

What is claimed is:

1. An unmanned aerial vehicle, comprising:
a first communication unit configured to communicate via a private communication protocol;
a second communication unit configured to communicate via a standard communication protocol; and
a controller unit configured to control the first communication unit and the second communication unit, wherein one of the first communication unit and the second communication unit is to communicate with a second unmanned aerial vehicle, and the other one of the first communication unit and the second communication unit is to communicate with a first remote controller.

2. The unmanned aerial vehicle of claim 1, wherein the controller unit is configured to control communications between the first communication unit and the first remote controller, and to control communications between the second communication unit and the second unmanned aerial vehicle.

3. The unmanned aerial vehicle of claim 1, wherein the controller unit is configured to control communications between the first communication unit and the second unmanned aerial vehicle, and to control communications between the second communication unit and the first remote controller.

4. The unmanned aerial vehicle of claim 2, wherein the controller unit is configured to control communications between the first communication unit and a second remote controller, and the second remote controller is configured to control the unmanned aerial vehicle.

5. The unmanned aerial vehicle of claim 3, wherein the controller unit is configured to control communications between the second communication unit and a second remote controller, and the second remote controller is configured to control the unmanned aerial vehicle.

6. The unmanned aerial vehicle of claim 1, wherein the first communication unit and the second communication unit operate at different operation frequencies.

7. The unmanned aerial vehicle of claim 1, wherein the controller unit is configured to control receipt of image information by the one of the first communication unit and the second communication unit from the second unmanned aerial vehicle, and to control transmission of the image information to the first remote controller via the other one of the first communication unit and the second communication unit.

8. The unmanned aerial vehicle of claim 7, wherein the controller unit is configured to further control transmission of image information captured by the unmanned aerial vehicle to the first remote controller via the other one of the first communication unit and the second communication unit.

9. The unmanned aerial vehicle of claim 1, wherein the private communication protocol includes OcuSync communication protocol.

10. The unmanned aerial vehicle of claim 1, wherein the standard communication protocol includes WiFi communication protocol.

11. An unmanned aerial vehicle system, comprising a first unmanned aerial vehicle and a first remote controller,
wherein the first unmanned aerial vehicle includes: a first communication unit to communicate via a private communication protocol; a second communication unit to communicate with a standard communication protocol; and a controller unit to control the first communication unit and the second communication unit, one of the first communication unit and the second communication unit communicating with a second unmanned aerial vehicle, and the other one of the first communication unit and the second communication unit communicating with the first remote controller, and
wherein the first remote controller controls the first unmanned aerial vehicle or controls the second unmanned aerial vehicle via communicating with the first unmanned aerial vehicle.

12. The unmanned aerial vehicle system of claim 11, wherein the controller unit is configured to control communications between the first communication unit and the first remote controller, and to control communications between the second communication unit and the second unmanned aerial vehicle.

13. The unmanned aerial vehicle system of claim 11, wherein the controller unit is configured to control communications between the first communication unit and the second unmanned aerial vehicle, and to control communications between the second communication unit and the first remote controller.

14. The unmanned aerial vehicle system of claim 12, wherein the controller unit is configured to control communications between the first communication unit and a second remote controller, and the second remote controller is configured to control the first unmanned aerial vehicle.

15. The unmanned aerial vehicle system of claim 13, wherein the controller unit is configured to control communications between the second communication unit and a second remote controller, and the second remote controller is configured to control the first unmanned aerial vehicle.

16. The unmanned aerial vehicle system of claim 11, wherein the first communication unit and the second communication unit operate at different operation frequencies.

17. The unmanned aerial vehicle system of claim 11, wherein the controller unit is configured to control receipt of image information by the one of the first communication unit and the second communication unit from the second unmanned aerial vehicle, and to control transmission of the image information to the first remote controller via the other one of the first communication unit and the second communication unit.

18. The unmanned aerial vehicle system of claim 17, wherein the controller unit is configured to further control transmission of image information captured by the first unmanned aerial vehicle to the first remote controller via the other one of the first communication unit and the second communication unit.

19. The unmanned aerial vehicle system of claim 11, wherein the private communication protocol includes OcuSync communication protocol.

20. The unmanned aerial vehicle system of claim 11, wherein the standard communication protocol includes WiFi communication protocol.
